(19) United States
(12) Patent Application Publication
(10) Pub. No.: US 2018/0001520 A1
(43) Pub. Date: Jan. 4, 2018

(54) RESIN COMPOSITION FOR SOLID FREEFORM FABRICATION AND METHOD OF MANUFACTURING SOLID FREEFORM FABRICATION OBJECT

(71) Applicants: Akira SAITO, Kanagawa (JP); Yoshihiro NORIKANE, Kanagawa (JP)

(72) Inventors: Akira SAITO, Kanagawa (JP); Yoshihiro NORIKANE, Kanagawa (JP)

(21) Appl. No.: 15/635,580

(22) Filed: Jun. 28, 2017

(30) Foreign Application Priority Data
Jul. 4, 2016 (JP) 2016-132640

(51) Int. Cl. B29C 39/36; C08K 5/12; C08G 63/00; B29C 39/02; C08G 65/48; C08G 65/40; C08K 3/22; C08K 5/092

(52) U.S. Cl. CPC B29C 39/36; C08K 3/22; C08K 5/12; C08K 5/092; B29C 39/02; C08G 65/485; C08G 65/4012; C08G 63/00; C08K 2003/2237

(57) ABSTRACT

A resin composition for solid freeform fabrication includes a thermoplastic resin, wherein the resin composition satisfies the following conditions 1 and 2. 1. The resin composition has a glass transition temperature (Tg) of 100 degrees C. or higher. 2. A molded object of the resin composition is dissolved in tetrahydrofuran at 25 degrees C. within 24 hours at a mass ratio (the molded object/tetrahydrofuran) of the molded object to tetrahydrofuran is 1/10 when the molded object is heated at 220 degrees C. for two hours.

### CROSS-REFERENCE TO RELATED APPLICATIONS

This patent application is based on and claims priority pursuant to 35 U.S.C. §119 to Japanese Patent Application No. 2016-132640, filed on Jul. 4, 2016, in the Japan Patent Office, the entire disclosure of which is hereby incorporated by reference herein.

### BACKGROUND

### Technical Field

The present disclosure relates to a resin composition for solid freeform fabrication and a method of manufacturing a solid freeform fabrication object.

### Description of the Related Art

3D modeling (additive manufacturing, etc.) technologies are appealing and widely used as modeling methods and materials diversify.

As the 3D modeling method, for example, fused deposition modeling (FDM) is known.

Powder bed fusion (PBF) is another method of 3D modeling. PBF includes selective laser sintering (SLS) to form an object by selective irradiation of laser beams and selective mask sintering (SMS) in which laser beams are applied in a planar manner using a mask.

For manufacturing utilizing FDM, specially hard polymers such as polyether imide (PEI) having a melting point of 200 degrees C. or higher referred to as super engineering plastic are used. However, since the super engineering plastic is discharged at high temperatures from a heating head, the resin greatly warps due to the temperature difference between the resin and the external environment. In an attempt to deal with this issue, devices capable of keeping (sustaining) temperatures of the external environment during fabrication are launched. However, if PEI is used as the modeling material, the temperatures are required to be 200 degrees C. or higher. Currently, no supporting material that can bear such high temperatures is found.

As the supporting material, materials soluble in a solvent or water are used. For example, polyvinyl alcohol (PVA) is used. In addition, materials dissolved in alkali solution can be also used. For example, a composition including carboxylic acid (specifically a copolymer resin of methacrylic acid and methyl methacrylate) as a base polymer and a plasticizer is known. Moreover, supports employing break-away method are known in which an additive such as a plasticizer to impart brittleness to a model material to be used is added for physical removal.

Moreover, supporting material is required to have thermal fusion property and heat resistance and must be easily removed. However, the supporting material using PVA has poor heat resistance.

In addition, material such as copolymer resins of methacylic acid and methyl methacrylate dissolved in alkali solution has a softening point of around 100 degrees C., starts decomposing at 200 degrees C. or higher, and demonstrates no flowability at around 240 degrees C. The alkali solution to be used is required to have a pH of 11 or higher, which causes a problem about safety. Moreover, methacrylic acid is hard and brittle and excessively lacks flexibility. Therefore, unless it contains a massive amount of plasticizer, the material of methacrylic acid may break by folding during conveyance of fabrication or cause trouble during conveyance in tubes having a high curvature. However, if a massive amount of plasticizer is used, dischargeability of resin solution such as bleaching tends to deteriorate in particular in high temperature and high moisture environment. Furthermore, if a supporting material to be physically removed is used, since the this supporting material is the same as the modeling material, the interface between the modeling material and the supporting material is not clear so that probability of breaking the modeling material is high. In addition, physical removal of the supporting material generally requires a great force with tools such as pliers. Accordingly, it takes a long time and degrades working efficiency. To make matters worse, removal of the supporting material is difficult at small gaps, etc.

### SUMMARY

According to an embodiment of the present disclosure, provided is an improved resin composition for solid freeform fabrication which includes a thermoplastic resin, wherein the resin composition satisfies the following conditions 1 and 2. 1. The resin composition has a glass transition temperature (Tg) of 100 degrees C. or higher. 2. A molded object of the resin composition is dissolved in tetrahydrofuran at 25 degrees C. within 24 hours at a mass ratio (the molded object/tetrahydrofuran) of the molded object to tetrahydrofuran is 1/10 after the molded object is heated at 220 degrees C. for two hours.

### BRIEF DESCRIPTION OF THE SEVERAL VIEWS OF THE DRAWINGS

Various other objects, features and attendant advantages of the present disclosure will be more fully appreciated as the same becomes better understood from the detailed description when considered in connection with the accompanying drawings in which like reference characters designate like corresponding parts throughout and wherein:

FIG. 1 is a diagram illustrating an example of the manufacturing device to mold the resin composition of the present disclosure in a fiber form; and

FIGS. 2A, 2B, and 2C are diagrams illustrating an example of a 3D object (solid freeform fabrication object) fabricated by using supporting material.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc. in the present disclosure represent the same meaning, unless otherwise specified.

Next, aspects of the present disclosure are described. Hereinafter, the resin composition for solid freeform fabrication is described as a support (supporting material) to support model portions of the 3D object (solid freeform fabrication object) but the present disclosure is not limited to the following embodiments.

The resin composition for solid freeform fabrication of the present disclosure includes a thermoplastic resin and satisfies the following conditions 1 and 2.

1. The resin composition has a glass transition temperature (Tg) is 100 degrees C. or higher.

2. A molded object is dissolved in tetrahydrofuran at 25 degrees C. within 24 hours at a mass ratio (the molded object/tetrahydrofuran) of the molded object to tetrahydrofuran is 1/10 after the molded object of the resin composition is heated at 220 degrees C. for two to eight hours.

The thermoplastic resin is preferably non-crystalline. The non-crystalline resin means that when a sample is measured by the method described in JIS K7121 (plastic transition temperature measuring method: ISO 3146), the graph obtained in differential scanning calorimetry (DSC) measuring has a small endothermic peak referred to as glass transition temperature (Tg) but no other large endothermic peaks thereafter.

The non-crystalline thermoplastic resin has excellent heat resistance and is easily dissolved in an organic solvent. For example, super engineering plastic resins are preferable as the non-crystalline thermoplastic resin. The super engineering plastic has a high decomposition temperature so that high temperatures can be set for heating heads. Also, it has a suitable melt viscosity and solubility in an organic solvent as a supporting material, which makes discharging from nozzles good. A particularly preferable example of such non-crystalline thermoplastic resin is a polyarylate-based resin.

Polyarylate-based resins are polycondensates of dihydric phenol and diprotic acid and have, for example, the following repeating unit.

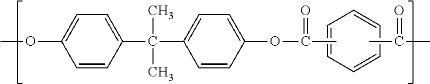

Polyarylate-based resins for use in the present disclosure can be a copolymer with other copolymerizable monomers in order to adjust flexibility and Tg as long as it has an adverse impact on the present disclosure. To enhance heat resistance, polyarylate-based resins may be subject to known distal end terminating treatment. Polyarylate-based resins in the present disclosure include such forms. It is also possible to mix with crystalline thermoplastic resins, which are described below.

In addition to this, it is also possible to use super engineering plastic of a crystalline thermoplastic resin. Examples are polymers (polyketone-based polymer) having a polyketone backbone and liquid crystal polymers (LCP). Of these, polyketone-based polymers are preferable.

Specific examples of polyketone-based polymer include, but are not limited to, polyether etherketone (PEEK), polyetherketone (PEK), polyether keone ketone (PEKK), polyaryl ether ketone (PAEK), polyaryl ketone (PAK), polyether ether ether ketone (PEEEK), polyether ether ketone ketone (PEEKK), polyetherketone ether ketone ketone (PEKEKK), and polyether ketone ketone ketone (PEKKK).

The crystalline thermoplastic resin of the present disclosure means crystalline resins having thermoplastic property. The crystalline resin has a melting peak as measured by ISO 3146 (plastic transition temperature measuring method JIS K7121).

Incidentally, some of the crystalline thermoplastic resin such as polyketone-based polymers are not easily dissolved in an organic solvent. In such a case, it is preferable to introduce a monomer to reduce crystalline property without degrading heat resistance as described below.

For example, in the case of PEEK, it is possible to synthesize PEEK by reacting one or more dihydroxy aromatic compounds and one or more dihydrobenzoid compounds or one or more halophenols, etc. at high temperatures under the presence of alkali catalyst. Below is a synthesis scheme using bisphenol A (BPA) as the dihydroxy aromatic compound and 4,4′-dichlorobenzphenone (DCBP) as the dihalobenzoid compound.

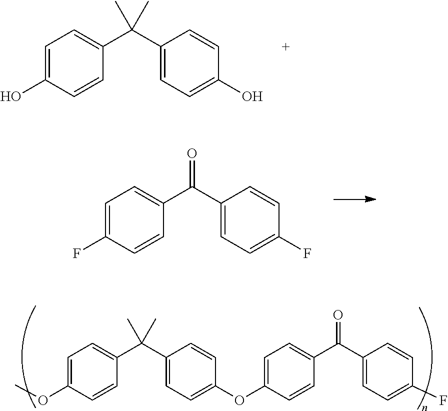

Another example is polymer B synthesized from the compound F illustrated below and a dihydroxy aromatic compound under the presence of an alkali catalyst. Below is a synthesis scheme using the compound F and bisphenol A (BPA) as the dihydroxy aromatic compound.

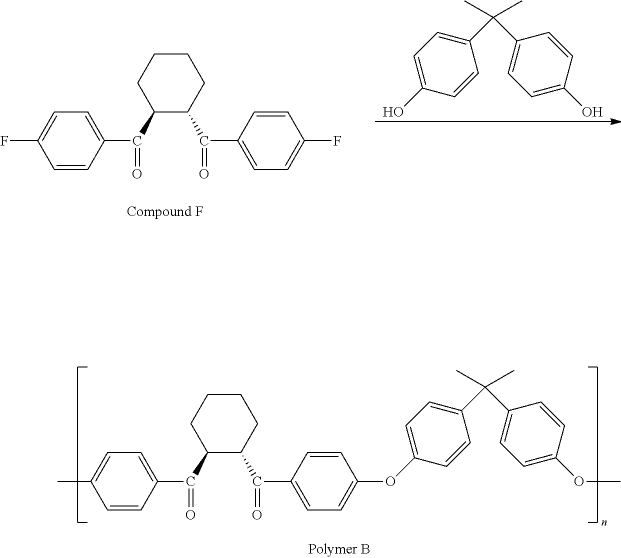

Specific examples of dihydroxy aromatic compound include, but are not limited to, bisphenol A (BPA), hydroquinone (HQ), bisphenol S (BPAS), tetrabromobisphenol (TBBA), and 4-tertiary-butylcatechol.

Specific examples of dihalobenzoid compound include, but are not limited to, 4,4′-dichlorobenzphenone (DCBP), 4,4′-difluorobanzphenone (DFBP), 4-chloro-4′-fluorobenzphenone, 4-(4-chlorobenzoyl)phenol, and (4-fluorobenzoyl)phenol.

In addition, to reduce crystalline property of polyketone-based polymer, one or more carbonyl groups (>C═O) contained in a polyketone-based polymer are substituted with diether (>C(OR)₂, where R represents alkyl, alkylene, alkynylene, allyl, aryl, alkenylene, etc.) to obtain a ketal polymer. Ketal may be hemiketal, thioketal, dithioketal, etc. These can be obtained by, for example, reaction of alcohol or thiol with a dihalobenzoid compound.

Polyketone-based polymer can be a combination of two or more kinds of polymers and also each block copolymer obtained by reacting distal ends. In addition, in order to impart flexibility, copolymers with rubber or polymer alloy are also usable. Moreover, it is also preferable to terminate distal ends of a polyketone-based polymer with chlorobenzene, phenol, naphthol, etc. to enhance heat resistance.

A preferable proportion of the thermoplastic resin to the total of the resin composition for solid freeform fabrication of the present disclosure is 20 to 100 percent by mass and more preferably from 60 to 100 percent by mass.

The resin composition for solid freeform fabrication of the present disclosure has a glass transition temperature (Tg) of 100 degrees C. or higher (condition 1) and demonstrates excellent heat resistance. When Tg is lower than 100 degrees C., heat resistance is not sufficient. Tg is more preferably from 100 to 250 degrees C. Tg is measured by differential scanning calorimetry (DSC) based on the method described in JIS K7121 (plastic transition temperature measuring method: ISO 3146).

The molded object of the resin composition of the present disclosure is dissolved in tetrahydrofuran at 25 degrees C. at a mass ratio (the model object/tetrahydrofuran) of the fabricated object to tetrahydrofuran of 1/10 within 24 hours after the molded object is heated at 220 degrees C. for two hours. Typical supporting material is not soluble in an organic solvent after exposed to such high temperatures for several hours.

The molded object has no particular limit. For example, it has a filament-like form. A specific example is a filament having a diameter of 1.75 mm and a length of 50 mm. The molded object can be suitably heated at 220 degrees C. by a known heating device. For example, a vacuum drier is usable. In addition, according to the condition 2, if the molded object of the resin composition of the present disclosure is heated at 220 degrees C. for two hours, it can be dissolved in tetrahydrofuran at 25 degrees C. at a mass ratio (the molded object/tetrahydrofuran) of the molded object to tetrahydrofuran of 1/10 within 24 hours. The heating temperature is preferably 240 degrees C. instead of 220 degrees C.

Moreover, it is preferable that the molded object be dissolved in THF at 25 degrees C. within 24 hours when the heating time is changed from two hours to any heating time between two and eight hours.

By satisfying the condition 2, when the resin composition for solid freeform fabrication of the present disclosure is used as the supporting material to support the model portion of a 3D object (solid freeform fabrication object), it is possible to easily remove the supporting material and impart excellent modeling property.

Being soluble in tetrahydrofuran (THF) as an organic solvent is also a requisite. However, the organic solvent is not limited thereto.

Specific other examples include, but are not limited to, ethyl acetate, toluene, xylene, acetone, acetonitrile, N,N-dimethyl formamide (DMF), dimethyl sulfoxide (DMSO), N-methyl pyrolidone (NMP), diethylene glycol monoether, triethylene glycol monoether, propylene glycol monomethylether acetate (PGMEA), propylene glycol monomethylether (PGME), ethylene acetate, triacetin, methylethyl ketone (MEK), methyl isobutyl ketone (MIBK), hexane, cyclohexane, dichloromethane, chloroform, pyridine, spearmint oil, carvon, N-methyl-2-pyrrolidone, limonene, methyl alcohol, dibenzylether, cresol, phenol, 1,2-propylene carbonate, dimethylether, and dimethylsiloxane. Of these, it is preferable that the molded object be soluble in THF, toluene, acetone, DMF, DMSO, PGMEA, PGME, MEK, hexane, spearmint oil, carvon, N-methyl-2-pyrrolidone, limonene, methyl alcohol, and dimethylether in terms of safety. It is more preferable that the molded object be soluble in acetone, cyclohexane, and spearmint oil. In the present disclosure, since a molded portion is easily removed without using a strong alkali material, it is possible to avoid risks ascribable to the usage of the strong alkali material. Also, such organic solvents do not cause environment pollution.

In the condition 2, “being soluble in THF within 24 hours” means that when the molded portion is immersed in THF, the molded portion is dissolved in THF or collapses and partially or totally loses its form within 24 hours.

The resin composition for solid freeform fabrication of the present disclosure preferably furthermore contains at least one kind of an inorganic compound and a lubricant. If these components are added, melt viscosity of the resin composition can be controlled to discharge an optimal amount thereof at applied temperatures when a 3D model is fabricated according to FDM method.

It is preferable that the inorganic compound and the lubricant maintain flowability and do not decompose, for example, when a nozzle temperature of 300 degrees C. or higher and a sustained temperature of 200 degrees C. or higher are adopted.

Specific examples of the inorganic compound include, but are not limited to, titanium oxide, barium sulfate, zinc oxide, aluminum nitride, alumina, kaolin, barium sulfate, silica, talc, clay, bentonite, magnesium carbonate, calcium carbonate, aluminum oxide, aluminum hydroxide, and mica. These can be used alone or in combination. Of these, titanium oxide, barium sulfate, alumina, silica, and talc are more preferable in terms of safety of liquid waste. Due to the addition of the inorganic compound, in addition to the above-mentioned, weight of the inorganic compound is applied to the thermoplastic resin so that solubility of the supporting material in the organic solvent increases.

There is no specific limitation to the addition amount of the inorganic compound. The content is preferably 50 parts by mass or less and more preferably from 5 to 25 parts by mass to 100 parts of the thermoplastic resin. Due to this addition of the inorganic compound, in addition to the above-mentioned, the molded object does not easily crack when folded. As the form of the inorganic compound, for example, powder-like form, particle-like form, and scale-like form are suitable. The inorganic compound can be surface-treated by a surface treating agent. The number average particle diameter of the primary particle of the inorganic compound has no particular limit and can be suitably selected to suit to a particular application. For example, it is preferably from 1 to 100 μm and more preferably from 5 to 50 μm. When the number average particle diameter of the primary particle of the inorganic compound is within the preferable range, viscosity of the composition does not increase when the composition is melted and dispersibility of the inorganic compound ameliorates.

The lubricant has no particular limit and can be suitably selected to suit to a particular application.

Specific examples include, but are not limited to, glycerin aliphatic acid esters, diglycerin aliphatic acid esters, higher alcohol aliphatic esters, hydrogenated castor oil, aliphatic acid amide, alisphatic acid amine, alkylenebisaliphatic acid amide, Japan wax, carnauba wax, whale wax, bee wax, lanoline, solid polyethylene glycol, magnesium carbonate, silicon dioxide, calcium stearate, magnesium stearate, and pyromellitic acid ester. These can be used alone or in combination. Of these, pyromellitic acid ester is preferable because it does not decompose at temperatures around 300 degrees C.

Due to the addition of a lubricant, the value of melt flow rate of the composition increases, thereby improving melt flowability due to heat. Therefore, it is possible to prevent breakdown of an extruder ascribable to overload particularly when a high pressure is required for extrusion.

There is no specific limitation to the addition amount of the lubricant. The content is preferably from 1 to 30 parts by mass and more preferably from 1 to 10 parts by mass to 100 parts by mass of the thermoplastic resin. When the content is within the preferable range, the value of melt flow rate increases so that melt flowability is improved.

From this point of view, the melt flow rate is preferably 0.5 g/10 minutes or less as the resin composition is measured according to the method described in JIS K7210 at 220 degrees C. and under a load of 2.16 kg.

The resin composition for solid freeform fabrication of the present disclosure may furthermore optionally include other components. The other optional components are not particularly limited and can be selected to suit to a suitable application. Examples thereof are resins, coloring materials, dispersants, and plasticizers.

In addition, taking into account high sustained temperatures, it is preferable to use heat stability imparting additives such as antioxidants.

The resin composition for solid freeform fabrication of the present disclosure is molded to have a predetermined form such as filament to fabricate a support (supporting material) to support the model portion of a 3D object (solid freeform fabrication object).

This molding process includes an extrusion process to extrude the resin composition and a cooling and solidifying process. The extrusion process is to melt-knead the composition to extrude the composition in a fibrous form. The extrusion process can be suitably conducted by an extruding device (extruder). The extruder includes, for example, single-shaft extruder, twin-shaft extruder, and a melt-kneading molding machine. The melt-kneading method is not particularly limited and can be suitably selected from known methods to suit to a particular application. For example, methods of continuously melt-kneading each component with a twin-shaft extruder, a single-shaft extruder, a melt-kneading molding machine, etc. or methods of melt-kneading each batch by a kneader, a mixer, etc., are suitable. If no additives are added, the melt-kneading process can be omitted. The cooling and solidifying process is to cool and solidify the thus-obtained extruded fibrous form composition. The cooling and solidifying process can be conducted by, for example, using a conveyor belt capable of extending and conveying the extruded fibrous form composition while blowing dried air thereto. The other optional processes are not particularly limited and can be selected to suit to a suitable application. Examples are a winding process and a control process. The winding process is to wind the composition cooled and solidified in the cooling and solidifying process. The winding process can be suitably conducted by a winder, etc.

An example of the manufacturing device to mold and manufacture the resin composition for solid freeform fabrication of the present disclosure in a fibrous form is described with reference to accompanying drawings.

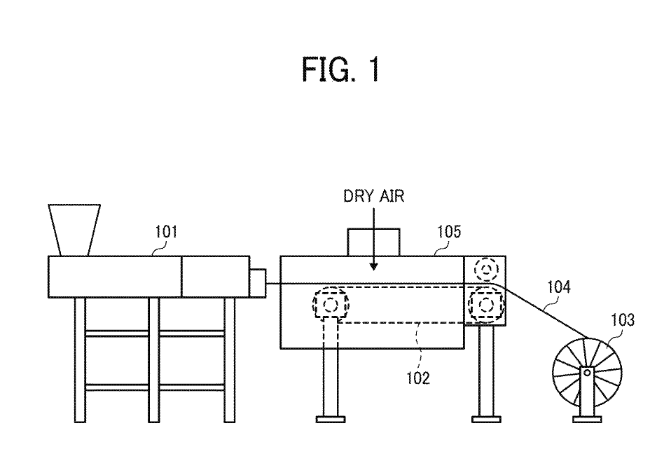

FIG. 1 is a diagram illustrating an example of the manufacturing device to mold and manufacture the composition of the present disclosure by molding in a fibrous form. As illustrated in FIG. 1, the resin composition for solid freeform fabrication discharged from a melt-kneading extruder 101 is supplied to a conveyor belt 102 covered with a dorm 105. The belt of the conveyor belt 102 has tucking property to prevent slipping of the fibrous composition. Stainless steel is used as the substrate of the belt. Silicone resin is applied to the surface thereof and thereafter the surface of the belt is subject to calendaring. Due to this, the resin composition follows the belt conveying speed so that the resin composition can be arbitrarily extended to adjust the diameter thereof. Dried air is supplied to the dorm 105, which includes a mechanism to cool and solidify the resin composition by the dried air to keep the fibrous form thereof. In this cooling and solidifying process, the resin composition can cooled and solidified by water-bathing to maintain the fibrous form. Thereafter, a resin composition 104 for solid freeform fabrication is wound up on a core by a winder 103 to obtain a filament for solid freeform fabrication.

Filament

The filament is suitably used as the supporting material in the manufacturing of a solid freeform fabrication object. The filament can be suitably used for a manufacturing device for a solid freeform fabrication object utilizing a fused deposition modeling (FDM) method. The diameter of the filament has no particular limit and can be suitably selected to suit to a particular application. For example, it is preferably from 1 to 5 mm and more preferably from 1.75 to 3 mm, which is typically used. The diameter of the filament can be controlled by extruding holes of a single shaft extruder, temperature conditions, tension conditions during winding, etc.

Method of Manufacturing 3D Object (Solid Freeform Fabrication Object)

The method of manufacturing a 3D object (solid freeform fabrication object) of the present disclosure includes a process of fabricating a support (supporting material) to support the model portion of the solid freeform fabrication object using the resin composition for solid freeform fabrication of the present disclosure. The method of manufacturing can be conducted by a known three-dimensional object fabricating device employing a fused deposition modeling (FDM) method. An example of the device is a known 3D printer. The device melts filament of the resin composition and discharges the melted filament while scanning to form a composition layer having a predetermined form and repeats this operation to laminate the layers. More specifically, using a 3D printer equipped with two or more melting heads, filament for modeling portion is used for one of the heads and filament for support made of the resin composition for solid freeform fabrication of the present disclosure is used for the other. Each filament is melted and discharged from the heads to form layers having predetermined forms of the support and the model portion. This operation is repeated to laminate layers to obtain a solid freeform fabrication object (3D object). In addition to this, like a knocking type ballpoint pen, it is possible to adopt a melting and discharging method in which fresh filament passes through one head via a cleaning process after usage. That is, the solid freeform fabrication object formed of the modeling material has a form corresponding to at least a part of the shape of the support forming material. In the present disclosure, since the supporting material is easily removed from the solid freeform fabrication object, the thus-obtained solid freeform fabrication object incurs less damage and has less remnants of the supporting material.

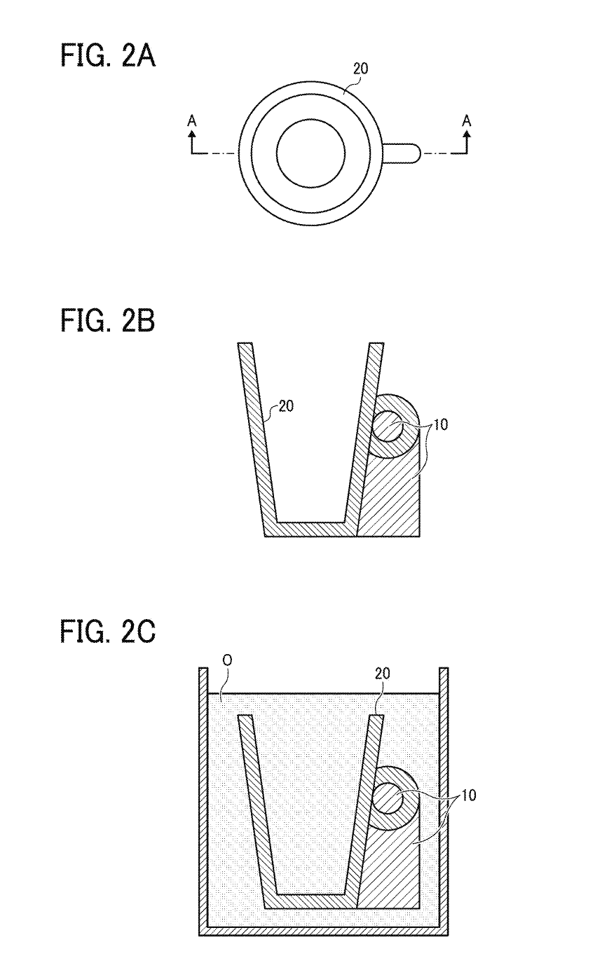

FIG. 2 is a diagram illustrating an example of the method of manufacturing a solid freeform fabrication object. FIG. 2A is a diagram illustrating a planar view of the solid freeform fabrication object including the supporting material. FIG. 2B is a diagram illustrating a cross section of the object relative to A-A line. When manufacturing a solid freeform fabrication object having a form illustrated in FIG. 2, a modeling material 20 and a supporting material 10 illustrated in FIG. 2B are repeatedly laminated by the method described above to obtain a united solid freeform fabrication object fabricated by the modeling material 20 and the supporting material 10. Without the supporting material 10, it is not possible to aesthetically shape the handle portion.

FIG. 2C is a diagram illustrating an example of the method of removing the supporting material 10 from the obtained united solid freeform fabrication object. When the solid freeform fabrication object is immersed in a vessel filled with an organic solvent O, only the supporting material 10 is dissolved or collapses in the organic solvent O so that the supporting material 10 can be completely removed to obtain a solid freeform fabrication object fabricated by the modeling material 20. In addition, since the resin composition for solid freeform fabrication has excellent heat resistance, it is possible to use a thermoplastic resin having a high glass transition temperature (Tg), for example, a resin composition having a glass transition temperature of 100 degrees C. or higher. as the modeling material 20.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but not limited thereto. “Percent” in Examples means “percent by mass”.

Manufacturing of Resin Composition for Solid Freeform Fabrication

### Examples 1 to 11

The materials used in Examples 1 to 5 are the following.

### Example 1: Polyarylate (U100, Manufactured by UNITIKA LTD.) Pellet

Example 2: polyarylate-based resin (M2040, manufactured by UNITIKA LTD.) pellet
Example 3: Mixture of 100 parts of the pellet of Example 1 and 15 parts of titanium oxide (R-62N, manufactured by SAKAI CHEMICAL INDUSTRY CO., LTD.)
Example 4: Mixture of 100 parts of the pellet of Example 1 and 15 parts of pyromellitic acid 2-ethylhexyl ester (UL-80, manufactured by ADEKA CORPORATION)
Example 5: Mixture of 100 parts of the pellet of Example 1, 15 parts of titanium oxide (R-62N, manufactured by SAKAI CHEMICAL INDUSTRY CO., LTD.), and 15 parts of pyromellitic acid ester (manufactured by ADEKA CORPORATION)
Example 6: Compound 1 synthesized as described below
Example 7: Mixture of 100 parts of Compound 1 synthesized as described below and 25 parts of titanium oxide (R-62N, manufactured by SAKAI CHEMICAL INDUSTRY CO., LTD.)
Example 8: Compound 2 synthesized as described below
Example 9: Mixture of 100 parts of Compound 2 synthesized as described below and 25 parts of pyromellitic acid 2-ethylhexyl ester (UL-80, manufactured by ADEKA CORPORATION)
Example 10: Compound 3 synthesized as described below
Example 11: Compound 4 synthesized as described below

Synthesis of Compound 1

345 g of BPA (reagent grade, manufactured by Sigma-]Aldrich Co. LLC.), 330 g of DFBP (reagent grade, manufactured by Sigma-Aldrich Co. LLC.), and 230 g of potassium carbonate (reagent grade, manufactured by TOKYO CHEMICAL INDUSTRY CO., LTD.) were charged in flask (four neck, 5 L) and 3,000 mL of DMSO were added thereto and the mixture was heated at 170 degrees C. for two hours (solvent distilled) and further heated (reflux) at 300 degrees C. for three hours. Thereafter, 3 g of DCBP (reagent grade, manufactured by Sigma-Aldrich Co. LLC.) was added and the resultant was slowly cooled down. Thereafter, the thus-obtained sample solution was charged in cold methanol during stirring to precipitate a polymer. Thereafter, the polymer was rinsed with water three times and thereafter dissolved in 1,000 ml of dichloromethane. The thus-obtained liquid was added to cold methanol again to precipitate the polymer again. The precipitated polymer was dried in atmosphere and sufficiently dried all night by a vacuum drier to obtain 600 g of Compound 1 as polymer.

Synthesis of Compound 2

345 g of BPA (reagent grade, manufactured by Sigma-Aldrich Co. LLC.), 320 g of DCBP (reagent grade, manufactured by Sigma-Aldrich Co. LLC.), 230 g of potassium carbonate (reagent grade, manufactured by TOKYO CHEMICAL INDUSTRY CO., LTD.) were charged in flask (four neck, 5 L) and 3,000 mL of DMSO were added thereto and the mixture was heated at 170 degrees C. for two hours (solvent distilled) and further heated (reflux) at 300 degrees C. for three hours. Thereafter, 3 g of DCBP (reagent grade, manufactured by Sigma-Aldrich Co. LLC.) was added and the resultant was slowly cooled down. Thereafter, the thus-obtained sample solution was charged in cold methanol during stirring to precipitate a polymer. Thereafter, the polymer was rinsed with water three times and thereafter dissolved in 1,000 ml of dichloromethane. The thus-obtained liquid was added to cold methanol again to precipitate the polymer again. The precipitated polymer was dried in atmosphere and sufficiently dried all night by a vacuum drier to obtain 600 g of Compound 2 as polymer.

Synthesis of Compound 3

115 g of PEEK (150XF, manufactured by Victrex plc.) and 1,000 mL of dichloromethane were charged in a flask (four neck, 2 L). 400 mL of tetrafluoroacetate (TFA, reagent grade, manufactured by Sigma-Aldrich Co. LLC.) was added thereto and thereafter 80 mL of propane diol was added thereto followed by stirring at room temperature for three days.

Thereafter, the thus-obtained sample solution was charged in cold methanol during stirring to precipitate a polymer. Thereafter, the polymer was rinsed with water three times and thereafter dissolved in 1,000 ml of dichloromethane. The thus-obtained liquid was added to cold methanol again to precipitate the polymer again. The precipitated polymer was dried in atmosphere and sufficiently dried all night by a vacuum drier to obtain 100 g of Compound 3 as polymer.

Synthesis of Compound 4

Synthesis of Compound F

1.6 g of aluminum (III) chloride (reagent, manufactured by Kishida Chemical Co., Ltd.) and 253 g of 1,2-cyclohexane dicarbonyl dichloride (manufactured by Taizhou Taifeng Chemical) were added to 231 g of fluorobenzene (reagent, manufactured by Wako Pure Chemical Industries, Ltd.). The mixture was placed in 1,000 mL of dichloromethane and stirred at room temperature for 24 hours. The resultant was separated in a column to obtain 300 g of Compound F with a yield of 65 percent.

Synthesis of Compound 4

345 g of BPA (reagent grade, manufactured by Sigma-Aldrich Co. LLC.), 300 g of Compound F, and 230 g of potassium carbonate (reagent grade, manufactured by TOKYO CHEMICAL INDUSTRY CO., LTD.) were placed in a flask (four neck, 5 L) and 3,000 mL of DMSO were added thereto. The resultant was heated in the flask at 170 degrees C. for two hours (solvent distilled) and further heated (reflux) at 300 degrees C. for three hours. Thereafter, 3 g of DCBP (reagent grade, manufactured by Sigma-Aldrich Co. LLC.) was added and the resultant was slowly cooled down. Thereafter, the thus-obtained sample solution was charged in cold methanol during stirring to precipitate a polymer. Thereafter, the polymer was rinsed with water three times and thereafter dissolved in 1,000 ml of dichloromethane. The thus-obtained liquid was added to cold methanol again to precipitate the polymer again. The precipitated polymer was dried in atmosphere and sufficiently dried all night by a vacuum drier to obtain 600 g of Compound 4 as polymer.

The material of each Example was placed in a plastic vessel (2,000 mL) and mixed and stirred by a big rotor (BR-2, manufactured by AS ONE Corporation.) at 10 rotation per minute (rpm) for one hour. Thereafter, using a kneading and extrusion evaluation tester (Labo Plastomill, manufactured by TOYO SEIKI KOGYO CO. LTD.), the material was melt-kneaded at a number of screw rotation of 15 rpm at a cylinder temperature of 300 degrees C. to extrude it in a filament-like form having a diameter of 1.75 mm and a length of 50 mm. Next, the thus-obtained filament was conveyed while being cooled down and solidified by dried air and wound up onto a core.

### Comparative Examples 1 to 3

The materials used in Comparative Examples 1 to 3 are the following.

Comparative Example 1: FDM method water-soluble supporting material (MAXX EXOTIC1063, PVA, manufactured by Leap frog)

Comparative Example 2: FDM method P400R Break away support material, polystyrene, manufactured by Stratasys Ltd.)

Comparative Example 3: polymethyl methacrylate (reagent grade, manufactured by Tokyo Chemical Industry Co., Ltd.)

The materials of Comparative Examples 1 to 3 were used in the same manner as in Examples 1 to 11 to obtain filament.

The temperature of the cylinder was 200 degrees C.

Evaluation on Melt Flowability

Melt flow rate (MFR) of the filaments of Examples 1 to 11 and Comparative Example 1 to 3 was measured at a temperature of 220 degrees C. and under a load of 2.16 kg using a melt indexer (LMI5000, based on JIS K7210, manufactured by Dynisco, LLC.). The evaluation results are as follows:

Comparative Example 1: 3.5 g/10 minutes

Comparative Example 2: 10 g/10 minutes or longer (too low a viscosity to measure)

Comparative Example 3: 10 g/10 minutes or longer (too low a viscosity to measure)

Example 1: 0.1 g/10 minutes

Example 2: 0.1 g/10 minutes

Example 3: 0.3 g/10 minutes

Example 4: 0.3 g/10 minutes

Example 5: 0.4 g/10 minutes

Example 6: 0.2 g/10 minutes

Example 7: 0.3 g/10 minutes

Example 8: 0.1 g/10 minutes

Example 9: 0.2 g/10 minutes

Example 10: 0.2 g/10 minutes

Example 11:0.3 g/10 minutes

Evaluation Criteria

A: MFR is 0.5 g/10 minutes or less

B: MFR is not less than 0.5 g/10 minutes

The results are shown in Table 1.

Measuring of Tg

Tg was measured by differential scanning calorimetry (DSC) based on the method described in JIS K7121 (plastic transition temperature measuring method: ISO 3146) about the filaments of Examples 1 to 11 and Comparative Examples 1 to 3.

The results are shown in Table 1.

Thermal Mass Measuring by TGA

After 5 to 10 mg of the filaments of Examples 1 to 11 and Comparative Examples 1 to 3 were collected, the filaments were measured according to JIS K7121 (plastic transition temperature measuring method) using a thermal analysis instrument (DTG-60, manufactured by Shimadzu Corporation). The temperature rising speed was 10 degrees C. per minute and the maximum temperature was 500 degrees C. The temperature (Td5) at which the mass was reduced 5 percent by mass from the mass before heating and the temperature (Td10) at which the mass was reduced 10 percent by mass from the mass before heating are shown in Table 1.

Solubility Test

After heating the vacuum drier equipped with a vacuum pump to 220 degrees C. or 240 degrees C., the filament of Examples 1 to 11 and Comparative Examples 1 to 3 were placed therein. The pressure was reduced until the vacuum meter indicated −10 MPa, and sampling was made at two hour later, four hours later, and eight hours later. Tetrahydrofuran (THF) (reagent grade, manufactured by Tokyo Chemical Industry Co., Ltd.) was added as an organic solvent to the sampling amount with a mass ratio of tetrahydrofuran to sampling of 10/1. In Comparative Examples, water was added instead of tetrahydrofuran. The liquid was left still at room temperature (25 degrees C.) for 24 hours to obtain a test liquid. Thereafter, each test liquid was subject to solubility evaluation as follows. The filament that was not able to maintain its form during heating was evaluated as −, which can be said as supporting material having no heat resistance.

The evaluation of solubility was made as follows.

The test liquid was filtrated through a weighed filter and the filter was dried at temperatures at which the solvent was evaporated in vacuum condition for 12 hours. Thereafter, the filter including remaining on the filter was weighed and the mass obtained by subtracting the mass of the filter was determined as the mass of the insoluble matter. When the mass of the insoluble matter was 20 percent or less to the filament initially used, it was rated as A. When the mass of the insoluble matter was not less than 20 percent, it was rated as B.

The result was shown in Table 1. In Comparative Example 1, the filament was colored in brown when heated and not dissolved in water for every heating time (not dissolved one week after the heating). In addition, in Comparative Example 2, since Tg of the resin was as low as 90 degrees C., it was dissolved during heating. In Comparative Example 3, the filament was colored due to the heat and decomposed and vaporized as time went by and almost all of the sample was lost.

TABLE 1

| | | | Thermal property | | |
|---|---|---|---|---|---|
| | | Tg | Td5 | Td10 | MFR |
| | Name of material | (degrees C.) | (degrees C.) | (degrees C.) | g/10 min |
| Comparative | Supporting material on the | 85 | 288 | 302 | B |
| Example 1 | market | | | | |
| Comparative | Supporting material on the | 90 | 290 | 310 | B |
| Example 2 | market | | | | |
| Comparative | Supporting material on the | 108 | 237 | 277 | B |
| Example 3 | market | | | | |
| Example 1 | PAR | 190 | 477 | 491 | A |
| Example 2 | PAR-based resin | 220 | 497 | 512 | A |
| Example 3 | PAR + titanium oxide | 190 | 470 | 485 | A |
| Example 4 | PAR + pyromellitic acid | | | | |
| | ester | 190 | 472 | 487 | A |
| Example 5 | PAR + titanium oxide + | 190 | 468 | 484 | A |
| | pyromellitic acid ester | | | | |
| Example 6 | Compound 1 | 120 | 350 | 370 | A |
| Example 7 | Compound 1 + titanium | 110 | 330 | 360 | A |
| | oxide | | | | |
| Example 8 | Compound 2 | 140 | 330 | 360 | A |
| Example 9 | Compound 2 + pyromellitic | 140 | 330 | 360 | A |
| | acid ester | | | | |
| Example 10 | Compound 3 | 145 | 350 | 370 | A |
| Example 11 | Compound 4 | 190 | 453 | 480 | A |

| | | Solubility test | | | | | | |
|---|---|---|---|---|---|---|---|---|
| | | | Heating at | | | Heating at 240 | | |
| | | Before | 220 degrees C. | | | degrees C. | | |
| | Name of material | heating | 2 h | 4 h | 8 h | 2 h | 4 h | 8 h |
| Comparative | Supporting material on the | A | B | B | B | B | B | B |
| Example 1 | market | (water) | | | | | | |
| Comparative | Supporting material on the | A | — | — | — | — | — | — |
| Example 2 | market | | | | | | | |
| Comparative | Supporting material on the | B | — | — | — | — | — | — |
| Example 3 | market | | | | | | | |
| Example 1 | PAR | A | A | A | A | A | A | A |
| Example 2 | PAR-based resin | A | A | A | A | A | A | A |
| Example 3 | PAR + titanium oxide | A | A | A | A | A | A | A |
| Example 4 | PAR + pyromellitic acid | A | A | A | A | A | A | A |
| | ester | | | | | | | |
| Example 5 | PAR + titanium oxide + | A | A | A | A | A | A | A |
| | pyromellitic acid ester | | | | | | | |
| Example 6 | Compound 1 | A | A | A | A | A | A | A |
| Example 7 | Compound 1 + titanium | A | A | A | A | A | A | A |
| | oxide | | | | | | | |
| Example 8 | Compound 2 | A | A | A | A | A | A | A |
| Example 9 | Compound 2 + pyromellitic | A | A | A | A | A | A | A |
| | acid ester | | | | | | | |
| Example 10 | Compound 3 | A | A | A | A | A | A | A |
| Example 11 | Compound 4 | A | A | A | A | A | A | A |

As seen in Table 1, the filament of each Examples has good heat resistance and excellent solubility. By contrast, the filament of Comparative Examples is inferior about heat resistance and solubility.

Organic Solvent Solution Test of Filaments of Examples 1 and 2

The filaments obtained in Examples 1 and 2 were weighed and immersed in each organic solvent shown in Table 2. The amount of the organic solvent was 10 times as much as that of the filament. The solubility of the filament was evaluated for the test liquid rested for 24 hours at 25 degrees C. according to the solubility evaluation described above.

The results are shown in Table 2.

TABLE 2

| | | Solvent | | | | |
|---|---|---|---|---|---|---|
| | | | | | Spearmint | |
| | | THF | NMP | acetone | oil | Cyclohexane |
| Example 1 | PAR | A | A | — | — | — |
| | filament | | | | | |
| Example 2 | PA-based | A | A | A | A | A |
| | resin | | | | | |
| | filament | | | | | |

As seen in Table 2, the filaments of Examples 1 and 2 were confirmed to be soluble in each organic solvent.

Organic Solvent Solution Test of Filaments of Examples 1, 3, 4, and 5

The filaments of Examples 1 and 2 were immersed in tetrahydrofuran (THF) at 25 degrees C. with a mass ratio of filament to tetrahydrofuran of 1/10 and the time to be taken for the filament to lose its form was checked. The results are shown in Table 3.

TABLE 3

| | Thermoplastic | Additive | | Solution |
|---|---|---|---|---|
| | resin | Titanium | pyromellitic | time |
| | PAR | oxide | acid ester | [min] |
| Example | 100 | 0 | 0 | 120 |
| 1 | | | | |
| Example | 85 | 15 | 0 | 80 |
| 3 | | | | |
| Example | 85 | 0 | 15 | 90 |
| 4 | | | | |
| Example | 70 | 15 | 15 | 50 |
| 5 | | | | |

As seen in Table 3, the solution time was found to be short when the inorganic compound and/or lubricant was added.

According to the present disclosure, an improved resin composition for solid freeform fabrication is provided, which has good heat resistance, removability, and fabrication property.

Having now fully described embodiments of the present disclosure, it will be apparent to one of ordinary skill in the art that many changes and modifications can be made thereto without departing from the spirit and scope of embodiments of the disclosure as set forth herein.

What is claimed is:

1. A resin composition for solid freeform fabrication, comprising:
a thermoplastic resin,
wherein the resin composition satisfies the following conditions (1) and (2),
(1). the resin composition has a glass transition temperature (Tg) of 100 degrees C. or higher, and
(2). a molded object of the resin composition is dissolved in tetrahydrofuran at 25 degrees C. within 24 hours at a mass ratio (the molded object/tetrahydrofuran) of the molded object to tetrahydrofuran is 1/10 after the molded object is heated at 220 degrees C. for two hours.

2. The resin composition according to claim 1, further comprising a compound selected from the group consisting of an inorganic compound and a lubricant.

3. The resin composition according to claim 2, wherein the inorganic compound includes at least one of titanium oxide, silica, and talc.

4. The resin composition according to claim 2, wherein the lubricant includes a pyromellitic ester.

5. The resin composition according to claim 1, wherein the thermoplastic resin includes a non-crystalline thermoplastic resin.

6. The resin composition according to claim 5, wherein the thermoplastic resin includes a polyarylate-based resin.

7. The resin composition according to claim 1, wherein the thermoplastic resin includes a crystalline thermoplastic resin.

8. The resin composition according to claim 7, wherein the crystalline thermoplastic resin includes a polyketone-based polymer having a polyketone backbone.

9. The resin composition according to claim 8, wherein the polyketone-based polymer includes polyether etherketone (PEEK), polyetherketone (PEK), polyether keone ketone (PEKK), polyaryl ether ketone (PAEK), polyaryl ketone (PAK), polyether ether ether ketone (PEEEK), polyether ether ketone ketone (PEEKK), polyetherketone ether ketone ketone (PEKEKK), and polyether ketone ketone ketone (PEKKK).

10. The resin composition according to claim 1, wherein, in the condition (2), the molded object of the resin composition is heated at 240 degrees C. for two hours.

11. The resin composition according to claim 1, wherein, in the condition (2), the molded object is dissolved in acetone, cyclohexane, spearmint oil, N-methyl-2-pyrrolidone, limonene, or methyl alcohol other than tetrahydrofuran.

12. The resin composition according to claim 1, wherein a melt flow rate is 0.5 g/10 minutes or less as the resin composition is measured at 220 degrees C. and under a load of 2.16 kg according to a method described in JIS K7210.

13. The resin composition according to claim 1, wherein the resin composition is a supporting material to support a model portion of a solid freeform fabrication object.

14. A method of manufacturing a solid freeform fabrication object, comprising:
manufacturing a model portion of the solid freeform fabrication object;
manufacturing a support to support the model portion with the resin composition for solid freeform fabrication of claim 1; and
removing the support from the solid freeform fabrication object.

15. The method according to claim 14, wherein the model portion includes a resin composition having a glass transition temperature (Tg) of 100 degrees C. or higher.

16. The method according to claim 14, further comprising dipping the support in an organic solvent to dissolve or collapse the support to remove the support.
wherein the removing comprising dipping the support in an organic solvent to dissolve or collapse the support.
